(19) United States
(12) Patent Application Publication
(10) Pub. No.: US 2011/0010756 A1
(43) Pub. Date: Jan. 13, 2011

(54) VIRTUAL APPLICATION PROGRAM SYSTEM, STORING DEVICE, METHOD FOR EXECUTING VIRTUAL APPLICATION PROGRAM AND METHOD FOR PROTECTING VIRTUAL ENVIRONMENT

(75) Inventors: Jong Uk Choi, Seoul (KR); Dongha Shin, Gyeonggi-do (KR); Sung Wook Jung, Gyeonggi-do (KR); Ji Yeon Kim, Seoul (KR); Muhammad Ali Malik, Seoul (KR); Samg Yup Shim, Seoul (KR); Hong Won Lee, Seoul (KR)

Correspondence Address: OCCHIUTI ROHLICEK & TSAO, LLP, 10 FAWCETT STREET, CAMBRIDGE, MA, 02138, US

(73) Assignee: MARKANY Inc., Seoul (KR)

(21) Appl. No.: 12/811,596

(22) PCT Filed: Dec. 31, 2008
(86) PCT No.: PCT/KR08/07857

§ 371 Date: Sep. 29, 2010

(30) Foreign Application Priority Data
Jan. 4, 2008 (KR) 10-2008-0001199
Mar. 11, 2008 (KR) 10-2008-0022462

(51) Int. Cl. G06F 21/00; G06F 9/00; G06F 9/445

(52) U.S. Cl. 726/2; 713/1; 718/1

(57) ABSTRACT

The present invention relates to a virtual application program system, a storage device, a method of executing a virtual application program, and a method of protecting a virtual environment. The virtual application program system includes an execution control module for executing a virtual application program, and a virtual environment protection module loaded by the execution control module and configured to block non-permitted application programs from accessing a virtual environment accessed by the virtual application program. Accordingly, the virtual environment can be protected from a host application program, etc., and independency and security of a task using a virtual application program can be guaranteed.

### TECHNICAL FIELD

The present invention relates to a virtual application program system, a storage device, a method of executing a virtual application program, and a method of protecting a virtual environment, and more particularly, to a virtual application program system and its related technologies, which is capable of protecting a virtual environment for executing a virtual application program and guaranteeing the independency and security of a task using a virtual application program.

### BACKGROUND ART

Recently, with the improved computing task environment through the development of digital technology and the popularization of an ultra-high speed Internet service, a variety of tasks performed by manual labor are replaced with computing tasks. For example, from the viewpoint of business, a user can edit a desired document in various forms using tools, such as Word or Worksheet, thus being capable of improving time and business efficiency.

Usually, in order to perform a desired computing task, a user can install an application program in a host computer, execute the application program, and write digital information using various functions provided by the corresponding application program. Here, the application program uses host resources included in the host computer. For example, the application program can access the file system and registry of the host in order to perform a task of reading or writing data.

However, the above conventional case is problematic in that it cannot support the mobility of a task. For example, in the case where a user performs a task using a specific application program in a host computer and stops the task, and subsequently wants to continue the task using the task data in another host computer, an application program that can support the task must be installed in the corresponding host computer. If the application program that can support the task is not installed, the user must obtain an installation CD or files and install the corresponding application program.

Accordingly, a variety of technologies have recently been researched in order to solve the problem. One of the representative researches is a virtual application program creation technology. The virtual application program creation technology refers to a technology for creating a unified portable program by virtualizing and packaging an application program. That is, an application program is made portable. Virtual application program creation tools that are available in the market include Thinstall, Autolt Macro Script, Auto Batch File, etc.

However, the above conventional technologies have problems in that they have low accuracy and a high error rate upon packaging because they perform packaging through an image comparison algorithm using Freescan and Postscan when creating a virtual application program. That is, the above conventional technologies do not create complete software, having an application program desired by a user, and only its related objects. Further, too many procedures must be performed in order to create a virtual application program, and processes thereof are also complicated.

In addition, the conventional technologies are disadvantageous in that they are vulnerable to security threats when performing a task using a virtual application program, and are problematic in that, after a task is performed, traces of the task remain in a host computer. For example, conventionally, other application programs can easily access host resources (for example, a file system or registry) used by a virtual application program and, even after a task, traces of the task may remain in the file system, the registry, etc.

As described above, the conventional technologies are problematic in that they do not sufficiently satisfy the independency and security of a virtual application program. Accordingly, there is an urgent need for virtualization and virtual application program related technologies which are capable of solving the problems.

### DISCLOSURE OF INVENTION

### Technical Problem

Accordingly, the present invention has been made in view of the above problems, and it is an object of the present invention to provide a virtual application program system, which is capable of guaranteeing security by blocking non-permitted application programs (for example, host application programs) from accessing a virtual environment where a virtual application program is executed.

It is another object of the present invention to provide a virtual application program system which is capable of installing and executing a virtual application program in a virtual environment isolated from a host environment.

It is still another object of the present invention to provide a portable storage device, which is capable of executing a virtual application program in which independency and security are guaranteed while the virtual application program operates in conjunction with a host.

It is further still another object of the present invention to provide a method of executing a virtual application program, which is capable of executing a virtual application program in an independent and secure environment.

It is further still another object of the present invention to provide a method of protecting a virtual environment, which is capable of protecting a virtual environment for executing a virtual application program from the outside.

### Technical Solution

To achieve the above objects, according to an aspect of the present invention, there is provided a virtual application program system. The virtual application program system includes an execution control module for executing a virtual application program, and a virtual environment protection module loaded by the execution control module and configured to block non-permitted application programs from accessing a virtual environment accessed by the virtual application program.

The virtual environment protection module may store pieces of unique ID information of application programs, which have been permitted to access the virtual environment, in a table and, if a specific application program attempts to access the virtual environment, may determine whether unique ID information of the specific application program exists in the table.

Here, the unique ID information may include at least one of a process ID and a message digest created by a corresponding application program. If the unique ID information is the process ID, the virtual environment protection module may store process IDs of processes generated by the application programs, which have been permitted to access the virtual environment, in a process ID table. If a process generated by a specific application program attempts to access the virtual environment, the virtual environment protection module may determine whether a process ID of the generated process exists in the process ID table.

If the unique ID information of the specific application program exists in the table, the virtual environment protection module may permit the specific application program to access the virtual environment. If the unique ID information of the specific application program does not exist in the table, the virtual environment protection module may do not permit the specific application program to access the virtual environment. Further, the virtual environment protection module may receive the unique ID information of the application program, which has been permitted to access the virtual environment, from at least one of the execution control module and the virtual application program.

The application program permitted to access the virtual environment may include at least one of the virtual application program and the execution control module.

The virtual environment protection module may include a virtual file system protection module for blocking the non-permitted application program from accessing a virtual file system accessed by the virtual application program, and a virtual registry protection module for blocking the non-permitted application programs from accessing a virtual registry accessed by the virtual application program.

Meanwhile, the virtual application program system may further include a virtual application program memory protection module for blocking the non-permitted application programs from accessing a memory region used by the virtual application program. The virtual environment protection module and the virtual application program memory protection module may be each configured in the form of a driver operating in a kernel mode.

The virtual application program memory protection module may store pieces of unique ID information of application programs, which have been permitted to access the memory region used by the virtual application program, in a table. If a specific application program attempts to access the memory region, the virtual application program memory protection module may determine whether unique ID information of the specific application program exists in the table. Further, the virtual application program memory protection module may block application programs from accessing physical memory.

The virtual application program system may further include a virtualization module for processing an application program interface (API) of an operating system so that the API conforms to the virtual environment, and a virtual application program installation module for configuring the virtual environment in a designated installation position using the virtualization module and installing the virtual application program in the virtual environment.

The virtualization module may include a file system virtualization module for, when the virtual application program calls an access API to a file system, converting an access path to the file system into an access path to a virtual file system, and a registry virtualization module for, when the virtual application program calls an access API to a registry, converting an access path to the registry into an access path to a virtual registry.

The virtual application program installation module may inject the virtualization module into an installation process of installing the virtual application program, and the execution control module may inject the virtualization module into an execution process of the virtual application program.

To achieve the above objects, according to another aspect of the present invention, there is provided a virtual application program system. The virtual application program system includes a virtualization module capable of, when a process calls an access API to a host environment, converting an access path to the host environment into an access path to a virtual environment, a virtual application program installation module for configuring the virtual environment in a designated position and installing a virtual application program in the virtual environment using the virtualization module, and an execution control module for executing the virtual application program in the virtual environment, which is independent and isolated from the host environment, using the virtualization module.

The virtual application program installation module may receive an installation position and position information of an installation file of an application program to be virtualized from a user, and install the virtual application program in the installation position by injecting the virtualization module into an installation process of the application program to be virtualized. Further, the execution control module may inject the virtualization module into an execution process of the virtual application program.

The virtual application program system may further include a virtual environment protection module for blocking non-permitted application programs from accessing the virtual environment accessed by the virtual application program.

The virtual environment may include a virtual file system and a virtual registry. The virtual environment protection module may include a virtual file system protection module for blocking the non-permitted application programs from accessing the virtual file system, and a virtual registry protection module for blocking the non-permitted application programs from accessing the virtual registry.

To achieve the above objects, according to still another aspect of the present invention, there is provided a storage device. A portable storage device operating in conjunction with a host system includes a virtual environment isolated from a host environment of the host system, a virtual application program accessing the virtual environment, and a virtual application program system for executing the virtual application program in the virtual environment and blocking non-permitted application programs from accessing the virtual environment.

Meanwhile, to achieve the above objects, according to further still another aspect of the present invention, there is provided a method of executing a virtual application program. The method includes the steps of loading a protection module for protecting a virtual environment, transferring unique ID information of a virtual application program, which can access the virtual environment, to the protection module, and executing the virtual application program.

The protection module may include at least one of a virtual file system protection module for blocking non-permitted application programs from accessing a virtual file system accessed by the virtual application program, a virtual registry protection module for blocking non-permitted application programs from accessing a virtual registry accessed by the virtual application program, and a virtual application program memory protection module for blocking non-permitted application programs from accessing a memory region used by the virtual application program or blocking application programs from accessing physical memory.

Meanwhile, to achieve the above objects, according to further still another aspect of the present invention, there is provided a method of protecting a virtual environment. The method includes the steps of storing unique ID information of a virtual application program, which can access a virtual environment, in the form of a table, if an application program attempts to access the virtual environment, determining whether unique ID information of the application program in the table, and if, as a result of the determination, the unique ID information of the application program is determined not to exist in the table, blocking the application program from accessing the virtual environment, and, if, as a result of the determination, the unique ID information of the application program is determined to exist in the table, permitting the application program to access the virtual environment. The unique ID information may include at least one of a process ID and a message digest created by a corresponding application program.

### ADVANTAGEOUS EFFECTS

As described above, according to the present invention, a virtual application program can be installed and executed in a virtual environment isolated from a host environment, and a virtual environment where a virtual application program is executed can be protected from non-permitted access. Accordingly, a virtual application program can be easily utilized when a digital task, requiring high independency and security, is performed.

### BRIEF DESCRIPTION OF DRAWINGS

FIG. 1 is block diagram showing the construction of a virtual application program system according to a preferred embodiment of the present invention;

FIG. 2 is a flowchart showing the operation of a virtual application program installation module of the virtual application program system;

FIG. 3 is a flowchart showing the operational flow of an execution control module of the virtual application program system;

FIG. 4 is an exemplary diagram showing an example in which a virtual application program accesses a virtual file system, a virtual registry, and so on;

FIG. 5 is an exemplary diagram showing an example in which a virtual file system protection module, a virtual registry protection module, and a virtual application program memory protection module protect a virtual environment and memory;

FIG. 6 is a flowchart showing the operational flow of a virtual file system protection module included in the virtual application program system;

FIG. 7 is a flowchart showing the operational flow of a virtual registry protection module included in the virtual application program system;

FIG. 8 is a flowchart showing the operational flow of a virtual application program memory protection module included in the virtual application program system; and

FIG. 9 is a flowchart showing the operation of the virtual application program memory protection module, which is included in the virtual application program system 100 and configured to block access to physical memory.

### DESCRIPTION OF REFERENCE NUMERALS OF PRINCIPAL ELEMENTS IN THE DRAWINGS

10: virtual application program installation module
20: virtualization module
22: file system virtualization module
24: registry virtualization module
30: virtual environment protection module
32: virtual file system protection module
34: virtual registry protection module
40: virtual application program memory protection module
50: execution control module
100: virtual application program system

### MODE FOR THE INVENTION

Preferred embodiments of the present invention will be described in detail below with reference to the accompanying drawings so that those skilled in the art can easily implement the present invention. In the preferred embodiments of the present invention, specific technical terminologies are used for the clarity of the contents. It is to be understood, however, that the present invention is not limited to the specific terminologies and each specific terminology includes all technical synonyms operating in a similar way in order to accomplish similar objects.

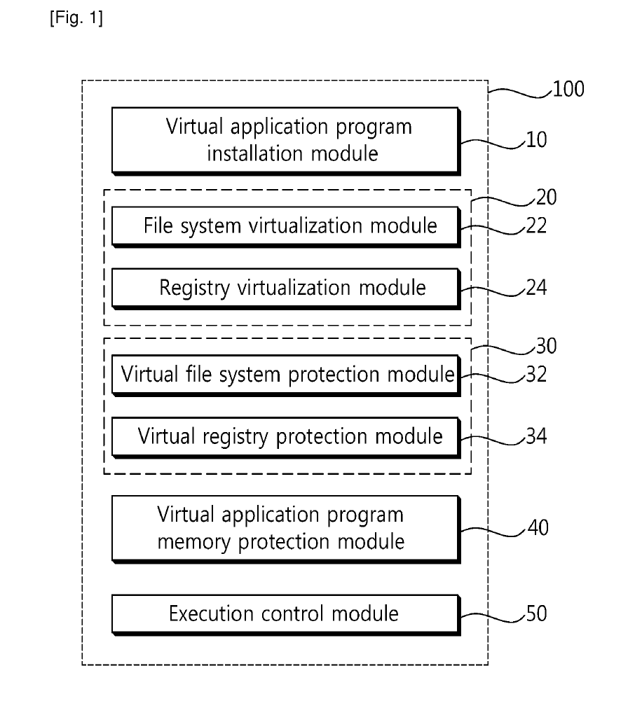

FIG. 1 is block diagram showing the construction of a virtual application program system according to a preferred embodiment of the present invention.

A virtual application program system 100 may include, as shown in FIG. 1, a virtual application program installation module 10, a virtualization module 20, a virtual environment protection module 30, a virtual application program memory protection module 40, and an execution control module 50.

The virtual application program installation module 10 functions to configure a virtual environment in a designated installation position and to virtualize and install an application program in the virtual environment. For example, the virtual application program installation module 10 may receive information about an installation position where a virtual application program will be installed and about the position of an installation file of an application program to be virtualized from a user, and then virtualize and install the application program in the corresponding installation position by injecting the virtualization module 20 into the installation process of the application program.

The installation position may include a portable external storage device, such as a USB memory card or a CD, storage space (for example, a hard disk) of a host computer, or storage space of a remote computer operating over a communication network. The virtual application program installation module 10 may configure a virtual environment (for example, a virtual file system and a virtual registry) in this installation position and install a virtual application program in the virtual environment. The installed virtual application program is independently executed in the virtual environment. Here, the virtual environment can have guaranteed security because it is prevented from being accessed by the outside (for example, host application programs and application programs of other computers).

The virtualization module 20 may function to virtualize the installation or execution of a virtual application program. The virtualization module 20 may include a dynamic ranking library having a number of function modules (for example, functions), which can redirect a native application program interface (API) of an operating system to a virtual environment. For example, the virtualization module 20 may be expressed by “Vm.dll,” (that is, a dynamic ranking library file) corresponding to “nt.dll” (that is, a Windows library file).

The virtualization module 20 is injected into an installation process or an execution process of a virtual application program by the virtual application program installation module 10 or the execution control module 50. If a process calls an access API to a host environment (for example, a file system or a registry), the virtualization module 20 may convert an access path into a virtual environment (for example, a virtual file system or a virtual registry) so that the corresponding process can be executed in the virtual environment. For example, if, when a virtual application program is installed or executed, a specific NTDLL function (that is, a Windows native API) of “ntdll.dll” (that is, a Windows native library) is called, the virtualization module 20 may perform a virtualization process so that the called Windows native API can execute a corresponding function in a virtual environment.

The virtualization module 20 may include a file system virtualization module 22 and a registry virtualization module 24. The file system virtualization module 22 and the registry virtualization module 24 may refer to library files comprising a number of function modules. The file system virtualization module 22 and the registry virtualization module 24 may be operated in a user mode.

If a virtual application program calls an access API to a file system, the file system virtualization module 22 may change an access path, which is used for this call, to the path of a virtual file system (for example, a directory environment defined in a virtual environment) and call the corresponding API. This file system virtualization module 22 may divide the file system of a kernel into a virtual file system, which can be accessed by only a virtual application program, and a host file system, which can be accessed by the application programs of a host.

If a virtual application program calls an access API to a registry, the registry virtualization module 24 may change an access path, which is used for this call, to the path of a virtual registry and call the corresponding API. This registry virtualization module 24 may divide the registry of a kernel into a virtual registry, which can be accessed by only a virtual application program, and a host registry, which can also be accessed by the application programs of a host.

The virtual environment protection module 30 functions to block non-permitted application programs (for example, host application programs) from accessing a virtual environment. For example, the virtual environment protection module 30 may function to block application programs, which do not belong to virtual application programs or the execution control module 50, from accessing a virtual file system or a virtual registry.

The virtual environment protection module 30 may include a virtual file system protection module 32 and a virtual registry protection module 34. The virtual file system protection module 32 and the virtual registry protection module 34 may be implemented in the form of a driver (for example, a mini filter) in a kernel mode.

The virtual file system protection module 32 functions to block an application program (for example, a host application program), which does not belong to permitted application programs (for example, a virtual application program or the execution control module 50) which can access a virtual file system, from accessing the virtual file system. For example, the virtual file system protection module 32 may receive path information of a virtual file system and unique ID information of an application program (for example, a virtual application program or the execution control module 50), which can access the virtual file system along the corresponding path, from a specific entity (for example, the execution control module 50 or a virtual application program). If an application program attempts to access a file within the virtual file system, the virtual file system protection module 32 may analyze unique ID information of the corresponding application program and, if, as a result of the analysis, the corresponding application program is not an application program permitted to access the file, block the corresponding application program from accessing the corresponding file.

The virtual registry protection module 34 functions to block a non-permitted application program (for example, a host application program), which do not belong to application programs permitted to access a virtual registry, from accessing the virtual registry. For example, the virtual registry protection module 34 may receive path information of a virtual registry and unique ID information of an application program (for example, a virtual application program or the execution control module 50), which can access the virtual registry along the corresponding path, from the execution control module 50 or a virtual application program. If an application program attempts to access a key within the virtual registry, the virtual registry protection module 34 may analyze unique ID information of the corresponding application program and, if, as a result of the analysis, the corresponding application program is not an application program permitted to access the key, block the corresponding application program from accessing the corresponding key.

The virtual application program memory protection module 40 functions to block an application program (for example, a host application program), which is not a permitted application program (for example, a virtual application program or the execution control module 50), from accessing a memory region used by the virtual application program. For example, the virtual application program memory protection module 40 may receive unique ID information of an application program, which is permitted to access the memory region used by the virtual application program, from the execution control module 50 or a virtual application program. If an application program attempts to access the memory region, the virtual application program memory protection module 40 may analyze unique ID information of the corresponding application program and, if, as a result of the analysis, the corresponding application program is not an application program permitted to access the memory region, block the corresponding application program from accessing the memory region. Here, the memory region may refer to logical memory. That is, the virtual application program memory protection module 40 may function to protect a logical memory region used by a virtual application program.

The virtual application program memory protection module 40 may also block an application program from accessing physical memory. It can prevent a specific application program from directly accessing physical memory and draining information therefrom (for example, hacking). The virtual application program memory protection module 40 may be implemented in the form of a driver (for example, a mini filter) in a kernel mode.

The execution control module 50 functions to operate the virtual environment protection module 30, the virtual application program memory protection module 40, and so on and execute a virtual application program. For example, the execution control module 50 may load the virtual environment protection module 30 and the virtual application program memory protection module 40 on a kernel mode stage and provide information necessary for the operations of the virtual environment protection module 30 and the virtual application program memory protection module 40. Further, the execution control module 50 may execute a virtual application program. When the corresponding virtual application program is executed, the execution control module 50 may inject the virtualization module 20 into a process so that the corresponding process is executed in a virtual environment (for example, a virtual file system and a virtual registry).

The execution control module 50 exists as one of application programs and may provide supplementary functions necessary to execute a virtual application program (for example, a user interface function for allowing a user to easily perform the virtual application program). For example, the execution control module 50 may provide a list of installed virtual application programs so that a user can select a desired virtual application program from the corresponding list.

The module configuration of the virtual application program system 100 has been schematically described above.

The operation of each of the modules of the virtual application program system 100 and an implementation example thereof are described in detail below.

First, the virtual application program installation module 10 may be an application program having an execution file (for example, an *.exe form). This virtual application program installation module 10 forms an execution icon, and may perform an operation when a user clicks on a corresponding icon. In this case, the virtual application program installation module 10 may also perform a function of installing the virtual application program system 100. For example, the virtualization module 20, the virtual environment protection module 30, the virtual application program memory protection module 40, the execution control module 50, and so on may be formed into one compression file form, and the virtual application program installation module 10 may install the virtual application program system 100 by decompressing the compression file at a specific position (it may be previously selected or may selected by a user).

Meanwhile, the virtual application program installation module 10 may be implemented as one of the functions of the execution control module 50. For example, an item capable of performing the virtual application program installation module 10 may be included in a menu provided by the execution control module 50 and, when a user selects the corresponding item, the virtual application program installation module 10 may perform an operation. As described above, the virtual application program installation module 10 may be implemented in various forms according to its implementation environments. In this description, the former case (a case where the virtual application program installation module 10 exists as an independent application program) is taken as an example. It is to be noted, however, that the present invention is not limited to the above case.

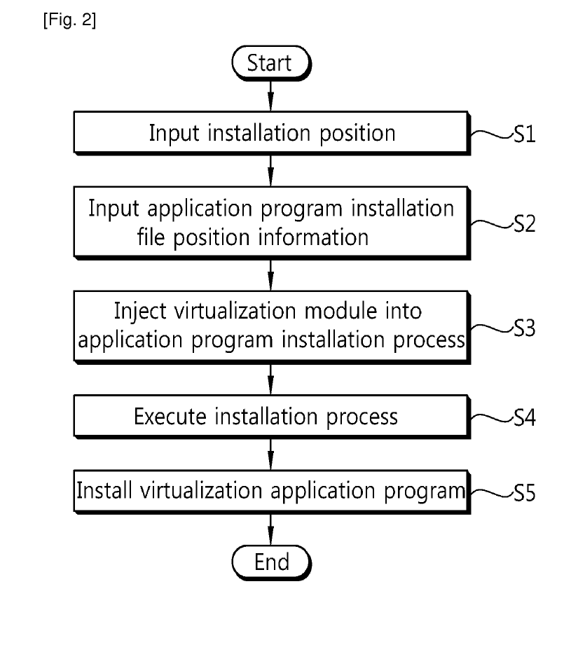

FIG. 2 is a flowchart showing the operation of the virtual application program installation module 10 of the virtual application program system.

Referring to FIG. 2, first, the virtual application program installation module 10 receives information of an installation position where a virtual application program will be installed from a user (step: S1). Here, the installation position may refer to a place where a virtual environment will be configured. For example, the virtual application program installation module 10 may provide a user with a directory selection window. If the user selects a desired directory (that is, the root directory of a virtual application program) as an installation position through the directory selection window, the virtual application program installation module 10 may store information of the corresponding directory. The installation position may include a portable external storage device, such as a USB memory card or a CD, storage space of a host computer, storage space of a remote computer, or the like.

The virtual application program installation module 10 receives position information of an installation file of an application program, which will be virtualized, from a user (step: S2). Here, the position information may refer to position information of an application program set-up file existing in a host computer, etc. (that is, information of a path along which a set-up file can be accessed). For example, the virtual application program installation module 10 may provide a user with a file selection window. If the user selects a set-up file of a desired application program through the file selection window, the virtual application program installation module 10 may store position information of the corresponding set-up file.

Next, the virtual application program installation module 10 injects the virtualization module 20 into an installation process of the application program to be virtualized (step: S3) and then enables the installation process of the application program to be executed (step: S4). If a file system or registry access API is called in the executed installation process of the application program, the virtualization module 20 redirects the corresponding access to a virtual path, and the API accesses the virtual file system and the virtual registry and performs a function. Accordingly, the virtualized application program (that is, a virtual application program) is installed in the installation position (step: S5).

The virtual application program installed as above may be executed by the execution control module 50. The execution control module 50 may be an application program which operates in the form of an execution file (for example, *.exe). The execution control module 50 may form an execution icon. In order to perform the virtual application program, a user may execute the execution control module 50 through a behavior, such as by clicking, for example, the execution icon of the execution control module 50. The execution control module 50 may be implemented in such a way as to operate according to a behavior, such as by clicking on the icon of a virtual application program. As described above, the execution control module 50 may be implemented in various forms according to its implementation environments. In this description, the former case (a case where the execution control module 50 exists as an application program) is taken as an example. It is to be noted, however, that the present invention is not limited to the above case.

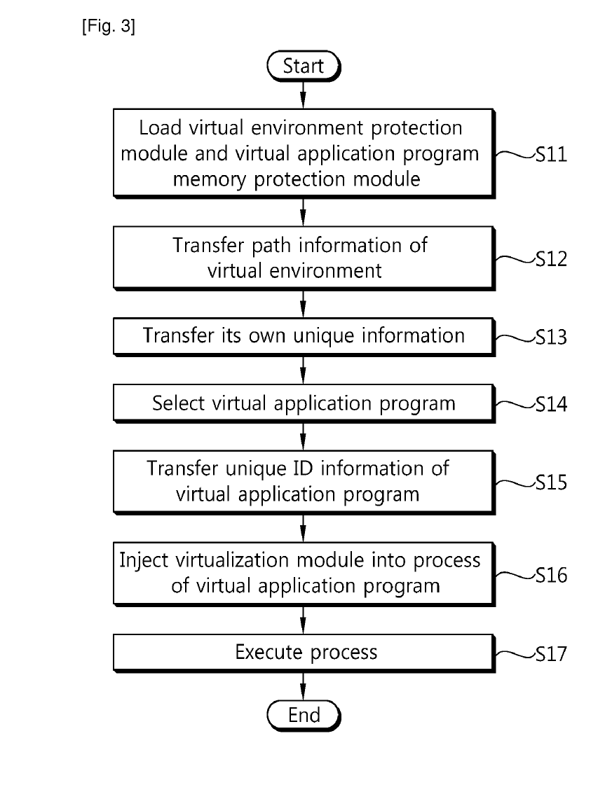

FIG. 3 is a flowchart showing the operational flow of the execution control module 50 of the virtual application program system 100.

Referring to FIG. 3, first, the execution control module 50 loads the virtual environment protection module 30 and the virtual application program memory protection module 40 (step: S11) and then transfers path information of a virtual environment (that is, a protection target) to the virtual environment protection module 30 (step: S12). For example, the execution control module 50 may load a virtual file system and the virtual registry protection module 34 and may respectively transfer path information of the virtual file system and path information of a virtual registry to the virtual file system and the virtual registry protection module 34.

The execution control module 50 also transfers its (that is, the execution control module 50) unique ID information to the virtual file system protection module 32 and the virtual registry protection module 34 of the virtual environment protection module 30 and the virtual application program memory protection module 40 (step: S13). Here, the unique ID information may include a process ID, a message digest, etc., which are created through a corresponding application program. The virtual environment protection module 30 and the virtual application program memory protection module 40 may store and manage the unique ID information, received from the execution control module 50, in a specific form (for example, a table form).

Meanwhile, the execution control module 50 may perform a user interface function necessary to perform a virtual application program. For example, the execution control module 50 may create an icon, indicating the driving of a virtual application program, and display the icon at a specific location (for example, a task bar). If a user selects the icon, the execution control module 50 may provide a menu (for example, a task bar pop-up menu) in a specific form. The menu may include a list of installed virtual application programs. Accordingly, a user can select a desired virtual application program through a menu provided by the execution control module 50 (step: S14).

When a user selects a virtual application program, the execution control module 50 enables the corresponding virtual application program to be executed. First, when a process is created by the corresponding virtual application program, the execution control module 50 may transfer the unique ID information (that is, a process ID, a message digest, etc., which are created through the corresponding application program) of the virtual application program to the virtual environment protection module 30 and the virtual application program memory protection module 40 (step: S15). The unique ID information of the virtual application program may also be transferred from the virtual application program to the corresponding modules 30 and 40. Further, the execution control module 50 may inject the virtualization module 20 (that is, the file system virtualization module 22 and the registry virtualization module 24) into the process of the virtual application program (step: S16). After this process, the execution control module 50 executes the process (step: S17). Accordingly, the virtual application program may be performed in the virtual environment.

After the execution of the virtual application program is completed, the execution control module 50 may unload the virtual file system protection module 32, the virtual registry protection module 34, and the virtual application program memory protection module 40.

Meanwhile, when a virtual application program is executed, a virtual file system accessed by the virtual application program, a virtual registry, and a memory region used by the virtual application program can be respectively protected by the virtual file system protection module 32, the virtual registry protection module 34, and the virtual application program memory protection module 40. In other words, only a corresponding virtual application program and only the execution control module 50 are permitted to access the virtual file system, the virtual registry, and the memory region used by the virtual application program, but non-permitted application programs (for example, host application programs) are blocked from accessing them.

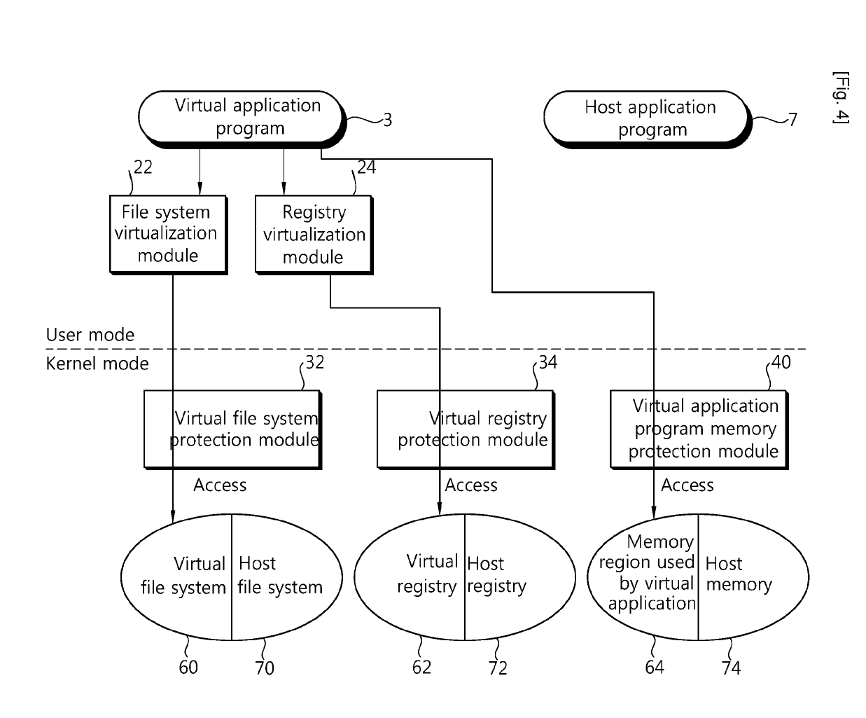

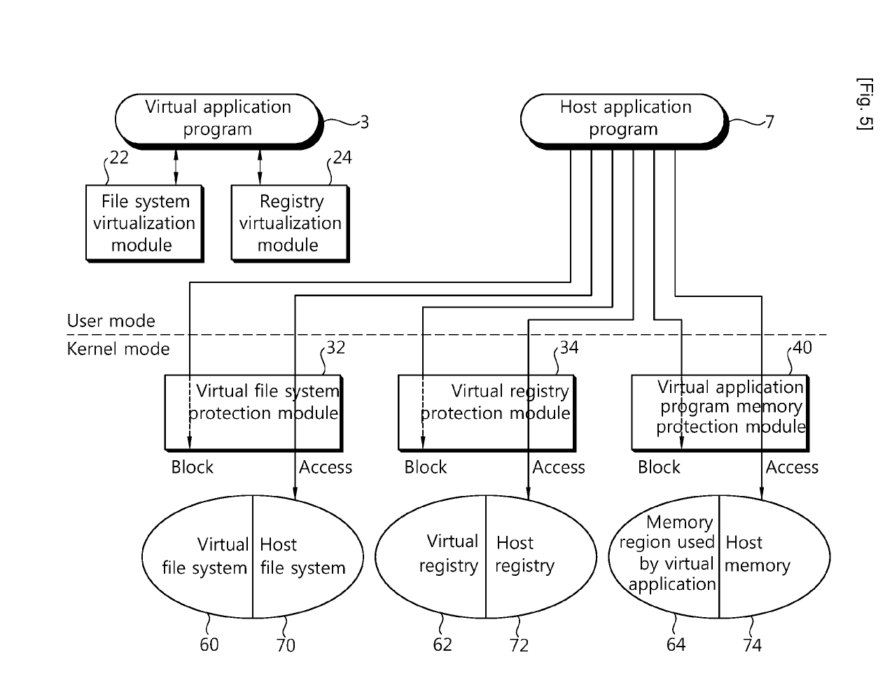

FIGS. 4 and 5 are exemplary diagrams showing the operation of the virtual application program system 100 when a virtual application program is executed. FIG. 4 shows an example in which a virtual application program 3 accesses a virtual file system 60, a virtual registry 62, etc. FIG. 5 shows an example in which the virtual file system protection module 32, the virtual registry protection module 34, and the virtual application program memory protection module 40 respectively block a host application program 7 from accessing the virtual file system 60, the virtual registry 62, and a memory region 64 used by the virtual application program 3.

As shown in FIGS. 4 and 5, the file system virtualization module 22 and the registry virtualization module 24 may operate in a user mode.

When the virtual application program 3 calls a file system access API, the file system virtualization module 22 converts an access path, used for this call, into the path of the virtual file system 60, and calls the corresponding API. Accordingly, the file system virtualization module 22 allows a process of the virtual application program 3 to access the virtual file system 60. A file system can be separated into the virtual file system 60, which can be accessed by only the virtual application program 3 and the execution control module 50, and a host file system 70, which can be accessed by the host application program 7, through this file system virtualization module 22.

When the virtual application program 3 calls a registry access API, the registry virtualization module 24 converts an access path, used for this call, into a virtual registry path and calls the corresponding API. Accordingly, the registry virtualization module 24 enables a process of the virtual application program 3 to access a virtual registry. A registry can be separated into the virtual registry 62, which can be accessed by only the virtual application program 3 and the execution control module 50, and a host registry 72, which can be accessed by the host application program 7, through this registry virtualization module 24.

Meanwhile, the virtual file system protection module 32, the virtual registry protection module 34, and the virtual application program memory protection module 40 may operate in a kernel mode. For example, they may be implemented in the form of a kernel driver, such as a mini filter driver of a kernel mode.

The virtual file system protection module 32 may perform a function of protecting the virtual file system 60 from non-permitted access by blocking non-permitted application programs (for example, the host application program 7), which do not belong to application programs (for example, the virtual application program 3 and the execution control module 50) permitted to access the virtual file system 60, from accessing the virtual file system 60.

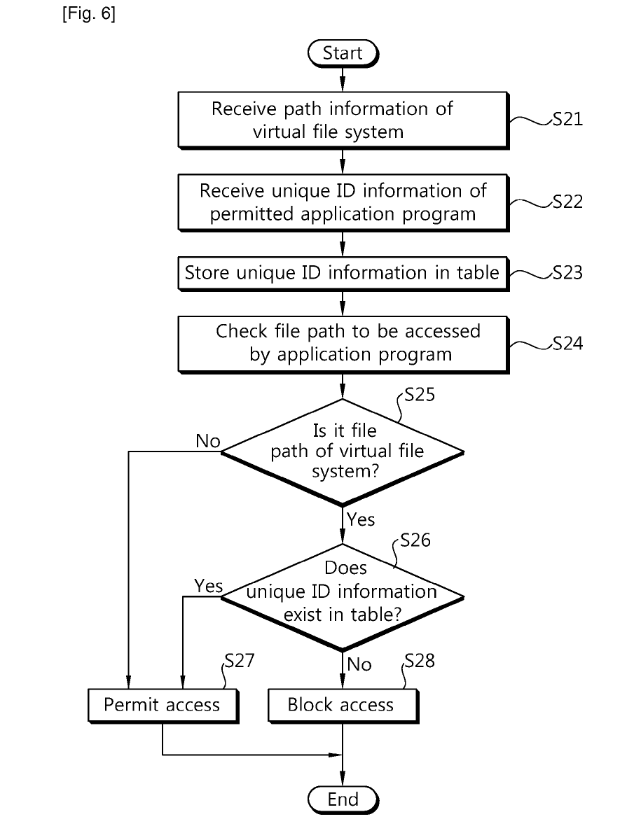

FIG. 6 is a flowchart showing the operational flow of the virtual file system protection module 32.

As shown in FIG. 6, the virtual file system protection module 32 is loaded by the execution control module 50 and then configured to receive path information of the virtual file system 60 from the execution control module 50 (step: S21). The virtual file system protection module 32 then receives pieces of unique ID information of application programs (that is, the execution control module 50 and the virtual application program 3), which are permitted to access the virtual file system 60, from the execution control module 50 or the virtual application program 3 (step: S22). Here, the unique ID information may include, as described above, a process ID, a message digest, etc., which are created through a corresponding application program. In the case of unique ID information of the virtual application program 3, the execution control module 50 may transfer the unique ID information to the virtual file system protection module 32 or the virtual application program 3 may transfer a child application program (for example, a process), which is generated by the virtual application program 3, to the virtual file system protection module 32. The virtual file system protection module 32 stores the pieces of unique ID information of the execution control module 50 and the virtual application program 3, which have been received from the execution control module 50 or the virtual application program 3, in a specific form (for example, a table form) (step: S23).

Next, the virtual file system protection module 32 checks the path of a file to be accessed by the application program (step: S24) and then determines whether the file path is a file path of the virtual file system 60 (step: S25). If, as a result of the determination, the file path to be accessed by the application program is determined not to be the file path of the virtual file system 60, the virtual file system protection module 32 permits the corresponding access (step: S27). However, if, as a result of the determination, the file path to be accessed by the application program is determined to be the file path of the virtual file system 60, it means access to the virtual file system 60. Accordingly, the virtual file system protection module 32 determines whether unique ID information of the application program exists in the stored table (that is, information including the unique ID information of the virtual application program and the execution control module 50) (step: S26). If, as a result of the determination, the unique ID information of the application program is determined not to exist in the table, the virtual file system protection module 32 blocks the access (step: S28). However, if, as a result of the determination, the unique ID information of the application program is determined to exist in the table, the virtual file system protection module 32 permits the access (step: S27).

In an alternative embodiment of the virtual file system protection process (steps: S21 to S28), assuming that the unique ID information is a process ID, the virtual file system protection module 32 may first receive path information of the virtual file system 60 from the execution control module 50, receive process IDs, which are created by the virtual application program 3 and the execution control module 50, from the virtual application program 3 or the execution control module 50, and store the received process ID in the form of a table. If a process generated by an application program attempts to access the virtual file system 60 along the file path of the virtual file system 60, the virtual file system protection module 32 may determine whether a process ID of the process exists in the table. If, as a result of the determination, the process ID is determined to exist in the table, the virtual file system protection module 32 may permit the access of the application program to the file of the virtual file system 60. However, if, as a result of the determination, the process ID is determined not to exist in the table, the virtual file system protection module 32 may block the access of the application program to the file of the virtual file system 60. Accordingly, only a process generated by the virtual application program 3 or the execution control module 50 can be permitted to access the virtual file system 60.

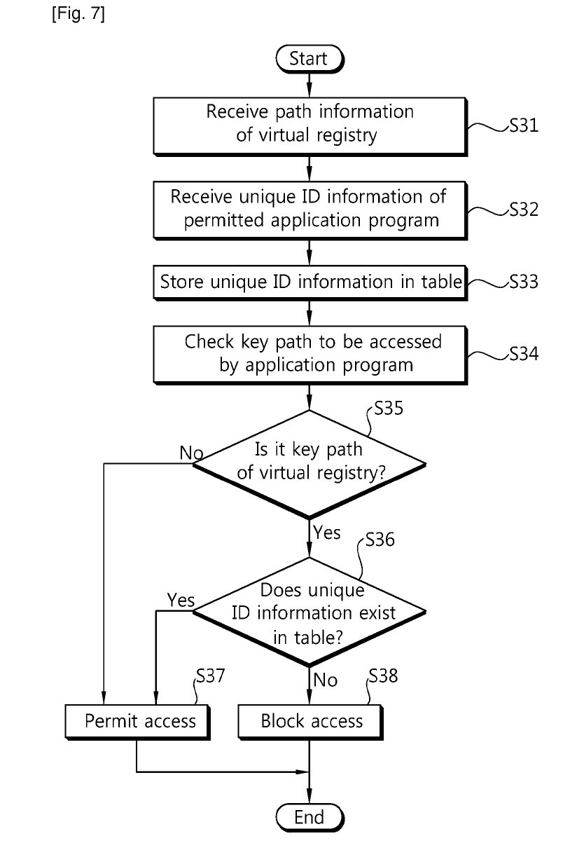

FIG. 7 is a flowchart showing the operational flow of the virtual registry protection module 34 included in the virtual application program system 100.

As shown in FIG. 7, the virtual registry protection module 34 is loaded by the execution control module 50 and then configured to receive path information of the virtual registry 62 from the execution control module 50 (step: S31). The virtual registry protection module 34 then receives pieces of unique ID information of application programs (that is, the execution control module 50 and the virtual application program 3), which are permitted to access the virtual registry 62, from the execution control module 50 or the virtual application program 3 (step: S32). Here, the unique ID information may include a process ID, a message digest, etc., which are created through a corresponding application program. In the case of unique ID information of the virtual application program 3, the execution control module 50 may transfer the unique ID information to the virtual registry protection module 34 or the virtual application program 3 may transfer a child application program (for example, a process), which is generated by the virtual application program 3, to the virtual registry protection module 34. The virtual registry protection module 34 stores the pieces of unique ID information of the execution control module 50 and the virtual application program 3, which have been received from the execution control module 50 or the virtual application program 3, in a specific form (for example, a table form) (step: S33).

Next, the virtual registry protection module 34 checks the path of a key to be accessed by the application program (step: S34) and then determines whether the key path is a key path of the virtual registry 62 (step: S35). If, as a result of the determination, the key path to be accessed by the application program is determined not to be the key path of the virtual registry 62, the virtual registry protection module 34 permits the corresponding access (step: S37). However, if, as a result of the determination, the key path to be accessed by the application program is determined to be the key path of the virtual registry 62, it means access to the virtual registry 62. Accordingly, the virtual registry protection module 34 determines whether unique ID information of the application program exists in the stored table (that is, information including the unique ID information of the virtual application program and the execution control module 50) (step: S36). If, as a result of the determination, the unique ID information of the application program is determined not to exist in the table, the virtual registry protection module 34 blocks the access (step: S38). However, if, as a result of the determination, the unique ID information of the application program is determined to exist in the table, the virtual registry protection module 34 permits the access (step: S37).

In an alternative embodiment of the virtual registry protection process (steps: S31 to S38), assuming that the unique ID information is a process ID, the virtual registry protection module 34 may first receive path information of the virtual registry 62 from the execution control module 50, receive process IDs, which are created by the virtual application program 3 and the execution control module 50, from the virtual application program 3 or the execution control module 50, and store the received process ID in a table. If a process generated by an application program attempts to access the virtual registry 62 along a key path of the virtual registry 62, the virtual registry protection module 34 may determine whether a process ID of the process exists in the table. If, as a result of the determination, the process ID is determined to exist in the table, the virtual registry protection module 34 may permit the access of the application program to the key of the virtual registry 62. However, if, as a result of the determination, the process ID is determined not to exist in the table, the virtual registry protection module 34 may block the access of the application program to the key of the virtual registry 62. Accordingly, only a process generated by the virtual application program 3 or the execution control module 50 can be permitted to access the virtual registry 62.

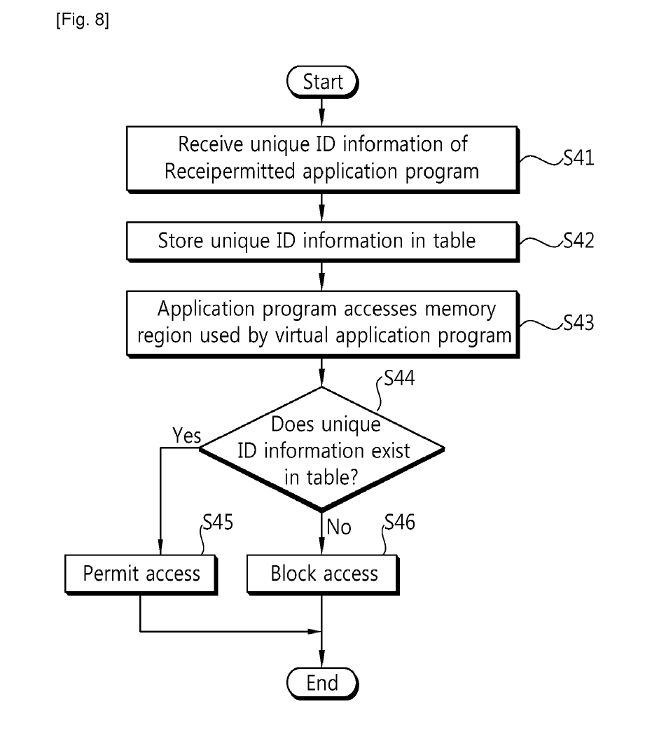

FIG. 8 is a flowchart showing the operational flow of the virtual application program memory protection module 40 included in the virtual application program system 100.

As shown in FIG. 8, the virtual application program memory protection module 40 receives pieces of unique ID information of application programs (for example, the execution control module 50 and the virtual application program 3), which are permitted to access the memory region 64 used by the virtual application program 3, from the execution control module 50 or the virtual application program 3 (step: S41). Here, the memory region 64 may be, as described above, a logical memory region. The unique ID information may also include a process ID, a message digest, etc., which are created through a corresponding application program. In the case of the unique ID information of the virtual application program 3, the execution control module 50 may transfer the unique ID information to the virtual application program memory protection module 40, or the virtual application program 3 may transfer a child application program (for example, a process), which is generated by the virtual application program 3, to the virtual application program memory protection module 40. The virtual application program memory protection module 40 may store the pieces of unique ID information of the execution control module 50 and the virtual application program 3, which have been received from the execution control module 50 or the virtual application program 3, in the form of a table, etc. (step: S42).

Next, if an application program attempts to access the memory region 64 used by the virtual application program 3 (step: S43), the virtual application program memory protection module 40 determines whether unique ID information of the corresponding application program exists in the stored table (that is, information including the unique ID information of the virtual application program and the execution control module 50) (step: S44). Here, if, as a result of the determination, the unique ID information of the application program is determined not to exist in the table (that is, when the application program attempting to access the memory region 64 is not the virtual application program or the execution control module 50), the virtual application program memory protection module 40 blocks the access of the corresponding application program to the memory region 64 (step: S46). However, if, as a result of the determination, the unique ID information of the application program is determined to exist in the table (that is, when the application program attempting to access the memory region 64 is the virtual application program or the execution control module 50), the virtual application program memory protection module 40 permits the access of the corresponding application program to the memory region 64 (step: S45).

In an alternative embodiment of the virtual memory region protection process (steps: S41 to S46), assuming that the unique ID information is a process ID, the virtual application program memory protection module 40 may receive process IDs, which are created by the virtual application program 3 and the execution control module 50, from the virtual application program 3 or the execution control module 50 and store the received process IDs in the form of a table. If, while the process generated by the virtual application program 3 is executed in a specific memory region 64, a process generated by an application program attempts to access the memory region 64, the virtual application program memory protection module 40 may determine whether the process ID of the process exists in the table by checking the table. If, as a result of the determination, the process ID of the process is determined to exist in the table, it means that the process is the process generated by the virtual application program 3 or the execution control module 50. Accordingly, the virtual application program memory protection module 40 permits the process to access the memory region 64. However, if, as a result of the determination, the process ID of the process is determined not to exist in the table, it means that the process is a non-permitted application program (for example, a host application program). Accordingly, the virtual application program memory protection module 40 blocks the process from accessing the memory region 64.

Meanwhile, the virtual application program memory protection module 40 may also block an application program from accessing physical memory.

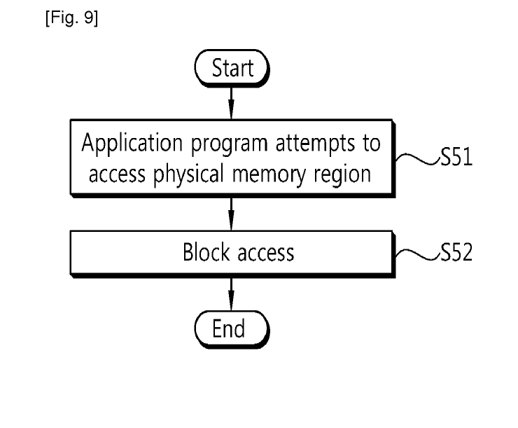

FIG. 9 is a flowchart showing the operation of the virtual application program memory protection module 40, which is included in the virtual application program system 100 and configured to block access to physical memory.

As shown in FIG. 9, if an application program attempts to directly access physical memory (step: S51), the virtual application program memory protection module 40 may block the application program from accessing the physical memory (step: S52). For example, if a process generated by a specific application program calls an API attempting to directly access physical memory (for example, RAM of a host computer), the virtual application program memory protection module 40 may return an error value which rejects access.

An application program typically accesses logical memory and performs a function, but does not perform direct access to physical memory. However, a person who has a contaminated will may directly access physical memory and drain information, using a specific application program. Accordingly, the virtual application program memory protection module 40 fundamentally blocks access to physical memory, thereby being capable of improving security.

As described above, the virtual application program system can install and execute a virtual application program in an independent virtual environment isolated from a host environment and can protect a virtual environment and memory using the virtual file system protection module, the virtual registry protection module, the virtual application program memory protection module, etc., which operate in a kernel mode.

This virtual application program system may find a variety of applications. For example, a user may include the virtual application program system in a portable external storage device (for example, USB memory, CD, DVD, and a mobile communication terminal), configure a virtual environment in the external storage device, and virtualize and install a desired application program in the virtual environment. Next, a user may connect the external storage device to a host computer and execute a virtual application program at any place where a computer terminal is provided, while carrying the external storage device.

In this case, the virtual application program is executed in an independent virtual environment isolated from the host computer. For example, the modification of a file and a registry, which is performed by the virtual application program, is performed only in a virtual file system and a virtual registry of the virtual environment configured in the external storage device. Further, the virtual environment can secure security because it is blocked from being accessed by non-permitted application programs, such as a host application program.

Accordingly, a user may virtualize and install application programs, such as Internet Explorer, Fire Fox, and Word Processor, in a portable external storage device, and then perform behaviors (for example, e-commerce and Internet banking), which require independency and security, using the virtual application program. In this case, a file or registry key that is created or modified is stored or modified only in a virtual environment, and non-permitted access to the virtual environment is all blocked. Accordingly, the drain of personal information can be fundamentally prevented because nothing information remains in a host computer.

As another example, a user may configure a virtual environment in a remote computer system, which operates over a communication network, and virtualize and install a virtual application program in the virtual environment, using the virtual application program system. In this case, the virtual application program may be independently performed in the virtual environment existing in the remote computer system. For example, the modification of a file and a registry, which is performed by the virtual application program, is performed only in a virtual file system and a virtual registry at a remote place. Here, other application programs included in the remote computer system may not access the corresponding virtual environment. Accordingly, a user can perform tasks requiring security using the remote computer system.

As still another example, a user may configure a virtual environment in a host computer and virtualize and install a virtual application program in the virtual environment, using the virtual application program system. In this case, the virtual application program may be independently executed in the virtual environment existing in a host computer. Here, other host application programs cannot access the virtual environment. Accordingly, tasks requiring security can be performed even within the host computer.

Although the preferred embodiments of the present invention have been described above, those having ordinary skill in the art will appreciate that the present invention may be modified in various forms without departing from the spirit and scope of the present invention defined in the appended claims. Accordingly, a possible change of the embodiments of the present invention may not deviate from the technology of the present invention.

1. A virtual application program system, comprising:
an execution control module for executing a virtual application program; and
a virtual environment protection module loaded by the execution control module and configured to block non-permitted application programs from accessing a virtual environment accessed by the virtual application program.

2. The virtual application program system of claim 1, wherein the virtual environment protection module stores pieces of unique ID information of application programs, which have been permitted to access the virtual environment, in a table and, if a specific application program attempts to access the virtual environment, determines whether unique ID information of the specific application program exists in the table.

3. The virtual application program system of claim 2, wherein the unique ID information comprises at least one of a process ID and a message digest created by a corresponding application program.

4. The virtual application program system of claim 3, wherein, if the unique ID information is the process ID, the virtual environment protection module stores process IDs of processes generated by the application programs, which have been permitted to access the virtual environment, in a process ID table and, if a process generated by a specific application program attempts to access the virtual environment, determines whether a process ID of the generated process exists in the process ID table.

5. The virtual application program system of claim 2, wherein the virtual environment protection module permits the specific application program to access the virtual environment if the unique ID information of the specific application program exists in the table, and does not permit the specific application program to access the virtual environment if the unique ID information of the specific application program does not exist in the table.

6. The virtual application program system of claim 2, wherein the virtual environment protection module receives the unique ID information of the application program, which has been permitted to access the virtual environment, from at least one of the execution control module and the virtual application program.

7. The virtual application program system of claim 2, wherein the application program permitted to access the virtual environment comprises at least one of the virtual application program and the execution control module.

8. The virtual application program system of claim 1, wherein the virtual environment protection module comprises:
a virtual file system protection module for blocking the non-permitted application program from accessing a virtual file system accessed by the virtual application program; and
a virtual registry protection module for blocking the non-permitted application programs from accessing a virtual registry accessed by the virtual application program.

9. The virtual application program system of claim 1, further comprising a virtual application program memory protection module for blocking the non-permitted application programs from accessing a memory region used by the virtual application program.

10. The virtual application program system of claim 9, wherein the virtual environment protection module and the virtual application program memory protection module are each configured in the form of a driver operating in a kernel mode.

11. The virtual application program system of claim 9, wherein the virtual application program memory protection module stores pieces of unique ID information of application programs, which have been permitted to access the memory region used by the virtual application program, in a table, and, if a specific application program attempts to access the memory region, determines whether unique ID information of the specific application program exists in the table.

12. The virtual application program system of claim 9, wherein the virtual application program memory protection module blocks application programs from accessing physical memory.

13. The virtual application program system of claim 1, further comprising:
a virtualization module for processing an application program interface (API) of an operating system so that the API conforms to the virtual environment; and
a virtual application program installation module for configuring the virtual environment in a designated installation position using the virtualization module and installing the virtual application program in the virtual environment.

14. The virtual application program system of claim 13, wherein the virtualization module comprises:
a file system virtualization module for, when the virtual application program calls an access API to a file system, converting an access path to the file system into an access path to a virtual file system; and
a registry virtualization module for, when the virtual application program calls an access API to a registry, converting an access path to the registry into an access path to a virtual registry.

15. The virtual application program system of claim 13, wherein:
the virtual application program installation module injects the virtualization module into an installation process of installing the virtual application program, and
the execution control module injects the virtualization module into an execution process of the virtual application program.

16. A virtual application program system, comprising:
a virtualization module capable of, when a process calls an access API to a host environment, converting an access path to the host environment into an access path to a virtual environment;
a virtual application program installation module for configuring the virtual environment in a designated position and installing a virtual application program in the virtual environment using the virtualization module; and
an execution control module for executing the virtual application program in the virtual environment, which is independent and isolated from the host environment, using the virtualization module.

17. The virtual application program system of claim 16, wherein the virtual application program installation module receives an installation position and position information of an installation file of an application program to be virtualized from a user, and installs the virtual application program in the installation position by injecting the virtualization module into an installation process of the application program to be virtualized.

18. The virtual application program system of claim 16, wherein the execution control module injects the virtualization module into an execution process of the virtual application program.

19. The virtual application program system of claim 16, further comprising a virtual environment protection module for blocking non-permitted application programs from accessing the virtual environment accessed by the virtual application program.

20. The virtual application program system of claim 19, wherein:
the virtual environment comprises a virtual file system and a virtual registry, and the virtual environment protection module comprises:
a virtual file system protection module for blocking the non-permitted application programs from accessing the virtual file system; and
a virtual registry protection module for blocking the non-permitted application programs from accessing the virtual registry.

21. A portable storage device operating in conjunction with a host system, comprising:
a virtual environment isolated from a host environment of the host system;
a virtual application program accessing the virtual environment; and
a virtual application program system for executing the virtual application program in the virtual environment and blocking non-permitted application programs from accessing the virtual environment.

22. A method of executing a virtual application program, comprising the steps of:
loading a protection module for protecting a virtual environment;
transferring unique ID information of a virtual application program, which can access the virtual environment, to the protection module; and
executing the virtual application program.

23. The method of claim 22, wherein the protection module comprises at least one of:
a virtual file system protection module for blocking non-permitted application programs from accessing a virtual file system accessed by the virtual application program;
a virtual registry protection module for blocking non-permitted application programs from accessing a virtual registry accessed by the virtual application program; and
a virtual application program memory protection module for blocking non-permitted application programs from accessing a memory region used by the virtual application program or blocking application programs from accessing physical memory.

24. A method of protecting a virtual environment, comprising the steps of:
storing unique ID information of a virtual application program, which can access a virtual environment, in the form of a table;
if an application program attempts to access the virtual environment, determining whether unique ID information of the application program in the table; and
if, as a result of the determination, the unique ID information of the application program is determined not to exist in the table, blocking the application program from accessing the virtual environment, and, if, as a result of the determination, the unique ID information of the application program is determined to exist in the table, permitting the application program to access the virtual environment.

25. The method of claim 24, wherein the unique ID information comprises at least one of a process ID and a message digest created by a corresponding application program.
